(19) United States
(12) Patent Application Publication
(10) Pub. No.: US 2015/0278526 A1
(43) Pub. Date: Oct. 1, 2015

(54) COMPUTERIZED SYSTEMS AND METHODS FOR PRESENTING SECURITY DEFECTS

(71) Applicant: Sourav Sam BHATTACHARYA, Fountain Hills, AZ (US)

(72) Inventor: Sourav Sam BHATTACHARYA, Fountain Hills, AZ (US)

(73) Assignee: Wipro Limited, Bangalore (IN)

(21) Appl. No.: 14/224,869

(22) Filed: Mar. 25, 2014

(51) Int. Cl. G06F 21/57; G06F 11/36; G06F 9/44

(52) U.S. Cl. CPC G06F 21/577; G06F 8/70; G06F 11/3692; G06F 2221/034

(57) ABSTRACT

Systems, methods, and computer-readable media for presenting and mitigating security defects in a systems development process. An example method is provided. The method comprises receiving a set of security defects, each of which may be associated with a severity level and a development stage. The method further comprises applying at least one rule to one of the received security defects to determine whether a risk associated with the at least one defects is reduced. Each rule may be associated with a weight representative of the probability that the rule correctly predicts that the risk is reduced. The method further comprises determining which of the rules applied to the at least one defect and appropriately modifying the associated severity level. The method further comprises presenting the received security defects, based on the severity level associated with each defect and the weight associated with a rule applied to each defect. Systems and computer-readable media are also provided.

### BRIEF DESCRIPTION

1. Field

The disclosure is generally directed to the field of security defect presentation and mitigation in a systems development process.

2. Background

The systems development life-cycle (“SDLC”) is a multi-phase process for implementing an information system, such as a software product or web application. The SDLC enables teams of workers to plan, create, test, and deploy the information system. The particular phases involved in an SDLC may vary, but generally include phases in developing an information system, such as planning the development of the system, determining how the system will be used (including determining an operating environment), designing the system, developing the system, debugging the system, revising the system, deploying the system, maintaining the deployed system, or evaluating the system.

For large-scale information systems, such as a distributed web-based application, security can be very important. Unfortunately, vulnerabilities can be introduced at nearly any stage of the SDLC. For example, the particular device used to implement an information system can have an impact on how secure the resulting system is. As another example, each time a line of code is written, one or more security vulnerabilities can be introduced, innocently or otherwise. Even planning the system to operate in a particular environment—such as on a publically accessible computer—can introduce vulnerabilities. Manually debugging code or careful planning alone can be time-consuming and result in missed vulnerabilities.

Embodiments of the disclosure may solve these problems as well as others.

### BRIEF SUMMARY

The disclosure provides systems, methods, and computer-readable media for presenting and mitigating security defects in a systems development process. An example method implemented in part on a hardware processor is provided. The method comprises receiving a set of security defects. Each security defect may be associated with a severity level and with a development stage in a systems development process (also known as a “systems development life-cycle” or “SDLC”). The method further comprises applying at least one rule to one of the received security defects, in order to determine whether a risk associated with the at least one defects is reduced. Each rule may be associated with a weight representative of the probability that the rule correctly predicts that the risk is reduced. The method further comprises, based on the applying step, determining which of the rules applied to the at least one defect, and modifying the severity level associated with the at least one defect. The method further comprises presenting the received security defects. The security defects may be presented based on the severity level associated with each defect and the weight associated with a rule applied to each defect.

A system is also provided. The system comprises at least one hardware processor and storage comprising instructions. The instructions are configured such that, when executed by the at least one hardware processor, they cause the hardware processor to perform the above method.

A non-transitory computer-readable medium is also provided. The medium comprises instructions that, when executed by the at least one hardware processor, cause the hardware processor to perform the above method.

Additional objects and advantages of the embodiments may be obvious from the description or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the embodiments as claimed.

The accompanying drawings, which are incorporated in and constitute a part of this specification, illustrate various embodiments and together with the description, serve to explain the principles of the embodiments.

### BRIEF DESCRIPTION OF THE DRAWINGS

FIG. 1 illustrates an example system diagram for sorting, prioritizing, reducing, and revising security test results, consistent with the disclosed embodiments.

FIG. 2 illustrates an example incident prioritization module for prioritizing security defects, consistent with the disclosed embodiments.

FIG. 3 illustrates an example false positive reduction module for reducing false positives between security defects, consistent with the disclosed embodiments.

FIG. 4 illustrates an example weight updating process for updating weights associated with each rule, consistent with the disclosed embodiments.

FIG. 5 illustrates an example rule application of 2-pair, 3-pair, and 4-pair rules to security defects across phases of the SDLC, consistent with the disclosed embodiments.

FIG. 6 illustrates an example computing device, consistent with the disclosed embodiments.

### DESCRIPTION OF THE EMBODIMENTS

Reference will now be made in detail to exemplary embodiments, examples of which are illustrated in the accompanying drawings. Wherever possible, the same reference numbers will be used throughout the drawings to refer to the same or like parts.

Embodiments of the present disclosure relate to presenting security defects related to a systems development life-cycle (“SDLC”). The defects may be received from a security testing system or other system. In some embodiments, the defects are categorized based on the stage of the SDLC in which they were detected. A defect can be matched to another defect based on a rule matching two or more defects of different stages to one another. Such rules are used to attempt to predict whether solving one of the matched defects will at least partially (i.e., partially or fully) solve one of the other matched defects. If the risk associated with a defect is reduced or nullified, the defect is said to be “partially” or “fully” solved (depending on whether there is still risk associated with the defect). The fully solved (“false positive”) defects can be filtered out to enable a user to more quickly process those defects that need to be addressed. Defects that are partially solved are given a lower severity, which also enables the user to more quickly process those defects that need to be addressed.

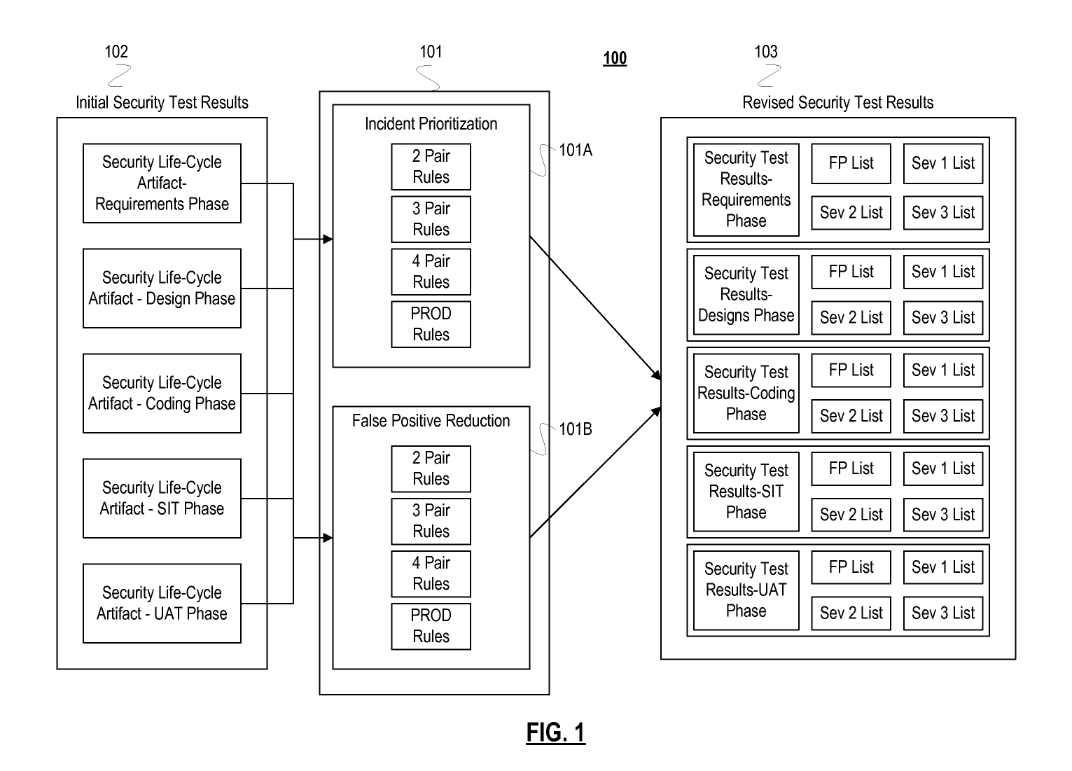

FIG. 1 illustrates an example system diagram 100 for sorting, prioritizing, reducing, and revising security test results, consistent with the disclosed embodiments. Diagram 100 includes a system 101 for receiving a set of initial security test results 102 associated with a subject information system, and outputting a set of revised security test results 103 associated with the subject system. System 101 comprises an incident prioritization module 101A and a false positive reduction module 101B. In some embodiments, system 101 may be implemented in the form of hardware, software (e.g., implemented on a computer or other electronic device), firmware, or any combination of the three.

Initial security test results 102 comprise, in some embodiments, one or more security defects identified during a security analysis process. Such a security analysis process could be performed, for example, by hand. In other embodiments, the analysis process could be performed using security or penetration testing software that analyzes software and/or the SDLC to determine vulnerabilities, bugs, or defects.

The one or more security defects can be categorized based on what phase of an SDLC the defects are associated with. A security defect is “associated with” an SDLC phase if the defect is introduced by or affected by some action taken as part of that SDLC phase. For example, if a security defect relates to a flaw in a computer on which the subject system is implemented, the defect may be classified as associated with the “requirements” phase of the SDLC. Similarly, if a defect relates to a library utilized by a programmer in writing the code for the system, the defect can be associated with the “coding” phase. (The particular phases listed in FIG. 1 are shown as an example; in other embodiments, more, fewer, or different phases are possible.)

In some embodiments, the analysis process may comprise receiving results from one or more security analysis tools (for example, one or more software programs or hardware devices). The one or more security analysis tools provide defects, and classify them as associated with one or more SDLC phases. For example, defects generated by a source code scanner could be classified as associated with a “coding” phase, and defects generated by a penetration testing tool could be classified as part of the “SIT” (“systems integration testing”) phase.

In some embodiments, similar security defects may be present across multiple phases. For example, if a test user reports that the subject system exposes sensitive data to unauthorized users, a first defect can be associated with the “coding” phase and a second defect can be associated with the “UAT” (User Acceptance Testing) phase. These defects may be related in that solving the defect associated with the coding phase may partially or fully solve the defect in the UAT phase.

In some embodiments, the defects in initial security test results 102 may be associated with a particular severity, based on the potential for loss related to the defects (the “risk”). For example, if a web page on the subject system does not obfuscate passwords entered by users by replacing each character with a ‘*’ (asterisk), the associated defect may be associated with a low severity, because the only way an attacker could take advantage of the vulnerability is by standing over the user's shoulder. As another example, if the subject system stores customer names and social security numbers on a remote system without encryption, the associated defect may be associated with a high severity, because of the high potential for loss. In some embodiments, the severity associated with each defect is one of a three-point scale (e.g., with a “severity 1 defect” being the highest and a “severity 3 defect” being the lowest), but other scales and severity measurements are possible as well. Furthermore, while a severity level may be related to the risk associated with a defect, the severity level may also be related to potential losses from the defect or other factors.

In some embodiments, each defect in initial security test results 102 may be categorized into a set of known defect types. For example, the Open Web Application Security Project (OWASP) provides a standardized list of vulnerabilities such as “Cross Site Scripting Flaw” (indicating a malicious script being surreptitiously inserted into an otherwise benign web page) or “Buffer Overflow” (indicating that a data buffer, such as memory corresponding to a text field, can potentially be misused to execute malicious code). Another list of vulnerabilities is known as the Common Weakness Enumeration (CWE), which includes vulnerabilities that are specific to particular drivers, software, or devices. (Other lists are possible as well, and the selection of a particular list is not required in all embodiments.) Each defect in initial security test results 102, in some embodiments, may be categorized into one of the standardized defects in these lists.

System 101 receives initial security test results 102 and processes them using one or more of incident prioritization module 101A or false positive reduction module 101B. Incident prioritization module 101A may be configured to receive initial security test results 102 and determines how likely it is that solving one or more of the defects in initial security test results 102 will partially solve or mitigate one or more defects from another phase of the SDLC. Incident prioritization module 101A determines those defects that are likely to be associated with one another using sets of rules. In the embodiment depicted in FIG. 1, incident prioritization module 101A has 2-pair rules, 3-pair rules, and 4-pair rules for matching two defects, three defects, and four defects, respectively, with one another. Incident prioritization module 101A matches defects from one phase with other phase(s) using these rules. As an example, a particular 2-pair rule can be triggered if cross site scripting defects are associated with both the design phase and the coding phase.

In some embodiments, rules consist of one or more requirements or improvements related to an SDLC (also known as “artifacts”) across one or more SDLC stages, and logic to associate the artifacts with one another. For example, a 2-pair rule may comprise a requirement to modify how a protocol is implemented in a “coding” stage, a requirement to enable communication between two devices in a “SIT” stage, and logic that associates the artifacts (here, the “requirements”) in the “coding” stage and the “SIT” stage. That 2-pair rule may be “triggered” if the artifacts associated with each stage actually exist in a particular SDLC.

In some embodiments, rules may be constructed in a “forward chaining” or “downstream chaining” model. “Forward chained” rules mean that, when a defect in an earlier stage of the SDLC is associated with a defect in a later stage of the SDLC, the earlier defect is assumed to solve the later defect, instead of the other way around. This assumption leads can mean that an earlier defect should be solved before attempting to solve the later defect, because solving the earlier defect may solve the later defect or may otherwise be more cost-effective than solving the later defect first. However, not all rules need be constructed in a forward chaining manner. For example, some rules may be implemented in a “backward chaining” model, whereby solving a later defect is more cost-effective or may solve an earlier defect. One example of such a rule may be to enforce a sandbox execution environment as part of solving a defect in a “SIT” phase, in order to mitigate certain defects associated with a “coding” stage.

If a rule is determined to be triggered by one or more defects, incident prioritization module 101A may be configured to determine whether solving the first defect partially solves the other defect(s). For example, there may be a first defect in the requirements phase, indicating that a router attached to the subject system has an older version of software, and a second defect in the systems integration testing (“SIT”) phase indicating that a vulnerability can be exploited through the older version of software on the router (among other avenues). Incident prioritization module 101A may then determine whether solving the first defect will partially solve the second defect.

Incident prioritization module 101A also, in some embodiments, implements special security rules known as production rules or “Prod rules.” Such rules relate to a determination that a security defect is partially mitigated based on changes in a production environment. For example, if a security defect relates to a determination that particular data stored at the subject system should be encrypted to prevent unauthorized access, and the subject system is implemented with a particularly strong firewall and/or intrusion detection system, a Prod rule can indicate that the defect is partially mitigated. By making the data harder to access, the risk associated with the data being unencrypted is diminished (but may not be entirely solved).

Incident prioritization module 101A may be configured to lower a severity level associated with a defect if that defect is partially solved by solving another defect, or if a Prod rule applies to the defect. For example, a first “severity 1” defect can be downgraded to a “severity 2” or “severity 3” defect if solving another defect partially solves the first defect or if a Prod rule applies to the defect.

False positive reduction module 101B may be configured to receive initial security test results 102 and determines how likely it is that solving one or more of the defects in initial security test results 102 will fully solve or completely mitigate one or more defects from another phase of the SDLC. Similar to incident prioritization module 101A, false positive reduction module 101B may also include 2-pair rules, 3-pair rules, and 4-pair rules for matching two defects, three defects, and four defects, respectively, with one another. False positive reduction module 101B matches defects from one phase with other phase(s) using these rules. If a rule is determined to be triggered by one or more defects, false positive reduction module 101B may attempt to determine whether solving the first defect fully solves the other defect(s).

False positive reduction module 101B also, in some embodiments, implements special security rules known as production rules or “Prod rules.” Such rules relate to a determination that a security defect is fully solved based on changes in a production environment.

False positive reduction module 101B may be configured to mark a defect as “false positive” (“FP”) if that defect is fully solved by solving another defect, or if a Prod rule fully solves the defect. If a defect is determined to be a “false positive” that does not necessarily mean that it is not a defect. Rather, a defect being marked as “false positive” refers to the fact that solving a different defect from a different stage will completely solve the defect. For example, if a test user reports that the subject system exposes sensitive data to unauthorized users, a first defect may be associated with both the “coding” phase and a second defect with the “UAT” phase. If the defect in the coding phase is solved, for example by rewriting the code that exposes the sensitive data, the defect in the UAT phase can be marked as a “false positive,” because the sensitive data is no longer shown to the user and the defect is fully solved.

Revised security test results 103 comprise categorized security defects from initial security test results 102. Incident prioritization module 101A and false positive module 101B may process initial security test results 102 to generate revised security test results 103. In some embodiments, the defects in revised security test results 103 are categorized both into an associated phase as well as the severity associated with the defect. For example, if a defect in the design phase is understood to be a “false positive” because of another defect in the requirements phase, the defect associated with the design phase may be listed in the “FP List,” which stands for “false positive list.” The defects categorized in the “severity 1” list may be understood to be the most severe defects, while those categorized in the “severity 3” list may be understood to be the least severe defects.

System 101 can present revised security test results 103 to a user. This enables the user to better determine the security defects that will not necessarily be addressed by addressing another security defect. In some embodiments, the presentation of revised security test results 103 can be based on the lists that the defects are categorized into. For example, system 101 may present only those defects in the “severity 1” list, or may prevent presentation of those defects in the FP list.

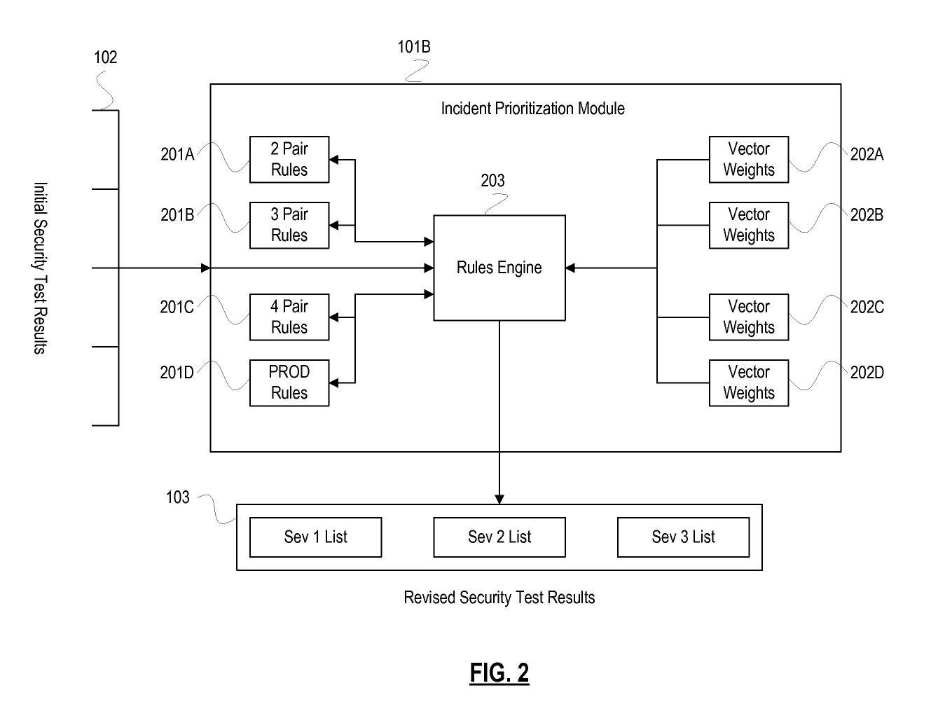

FIG. 2 illustrates an example incident prioritization module 101A for prioritizing security defects, consistent with the disclosed embodiments. In the disclosed embodiments, incident prioritization module 101A contains one or more 2-pair rules 201A, one or more 3-pair rules 201B, one or more 4-pair rules 201C, and one or more Prod rules 201D. Incident prioritization module 101A, in some embodiments, uses 2-pair rules 201A, 3-pair rules 201B, and 4-pair rules 201C, to match a defect in one stage with one or more defects in other stages. For example, one of 2-pair rules 201A can be used to match a cross site scripting defect in both the design and the coding phases.

Each of rules 201A-201D have corresponding vector weights 202A-202D. Vector weights 202A-202D relate to the likelihood that a particular rule that matches one or more defects is likely to solve one of defects. For example, if a 2-pair rule matches a first defect from a first phase with a second defect from a second phase, the weight associated with that rule relates to the likelihood that solving the first defect will partially solve the second defect. In some embodiments, the weights may be numerical in nature (e.g., “0.8” representing an 80% likelihood), and may be presented as part of revised security test results 103 (depicted in FIG. 1).

Incident prioritization module 101A also includes a rules engine 203. Rules engine 203 may be configured to utilize one or more of the rules 201A-201D to match defects across different phases. Rules engine 203 may generate a portion of revised security test results 103. In some embodiments, the portion of revised security test results 103 generated by incident prioritization module 101A comprises the defects from initial security test results 101. Rules engine 203 may also categorize the defects into one of multiple severity levels based on the results of matching the defects. In some embodiments, the portion of revised security test results 102 generated by rules engine 203 may comprise security defects from initial security test results 101, divided into one or more lists representing the severity of each defect. For example, as explained above, defects may be categorized into one of three severity categories (severity 1, severity 2, or severity 3).

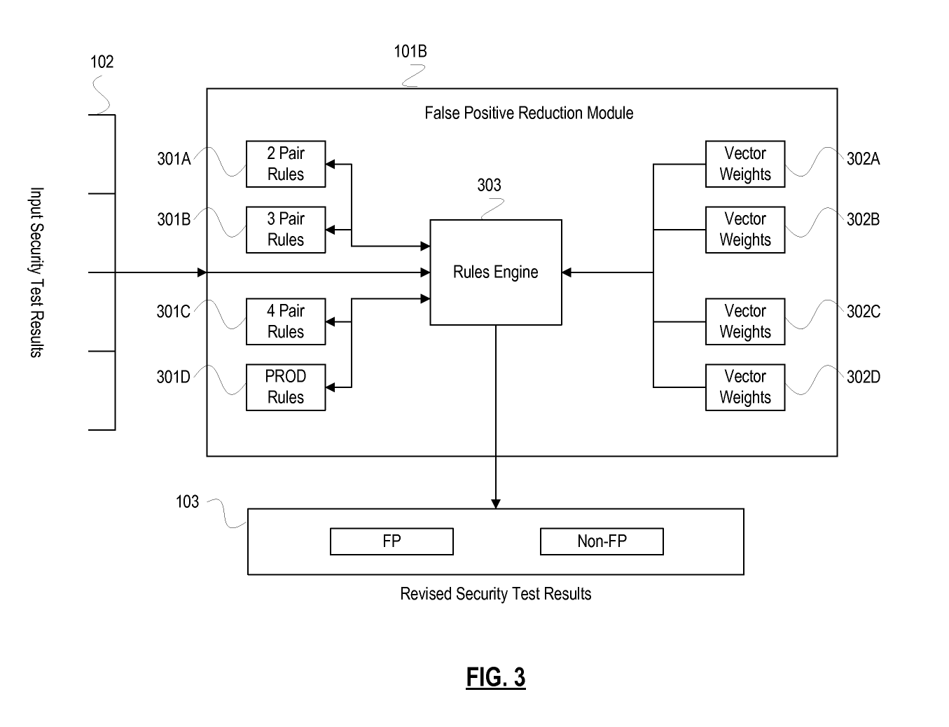

FIG. 3 illustrates an example false positive reduction module 101B for reducing false positives between security defects, consistent with the disclosed embodiments. In the disclosed embodiments, false positive reduction module 101B contains one or more 2-pair rules 301A, one or more 3-pair rules 301B, one or more 4-pair rules 301C, and one or more Prod rules 301D. (In some embodiments, the rules in false positive reduction module 101B may be the same as rules 201A-201D in incident prioritization module 101A, but this is not required in all embodiments.) False positive reduction module 101B, in some embodiments, uses 2-pair rules 301A, 3-pair rules 301B, and 4-pair rules 301C, to match a defect in one stage with one or more defects in other stages.

Each of rules 301A-301D have corresponding vector weights 302A-302D. Vector weights 302A-302D relate to the likelihood that a particular rule that matches one or more defects is likely to solve one of defects. For example, if a 2-pair rule matches a first defect from a first phase with a second defect from a second phase, the weight associated with that rule relates to the likelihood that solving the first defect will fully solve the second defect. In some embodiments, the weights may be numerical in nature (e.g., “0.2” for a 20% likelihood), and may be presented as part of revised security test results 103 (depicted in FIG. 1).

False positive reduction module 101B also includes a rules engine 303. Rules engine 303 may be configured to utilize one or more of the rules 301A-301D to match defects across different phases. Rules engine 303 may generate a portion of revised security test results 102. In some embodiments, the portion of revised security test results 102 generated by false positive reduction module 101B comprises the defects from initial security test results 101, divided into two groups. The defects may be divided into a first group of defects determined to be “false positive” (“FP”) and a second group of defects determined not to be “false positive” (“non-FP”). As mentioned above, the FP defects may be associated with a likelihood that the defects will actually be solved (based in part on the weight associated with the rule that matched the defect with other defect(s)). The likelihood associated with each FP defect may be presented to a user, which enables the user to determine whether or not further investigation is necessary.

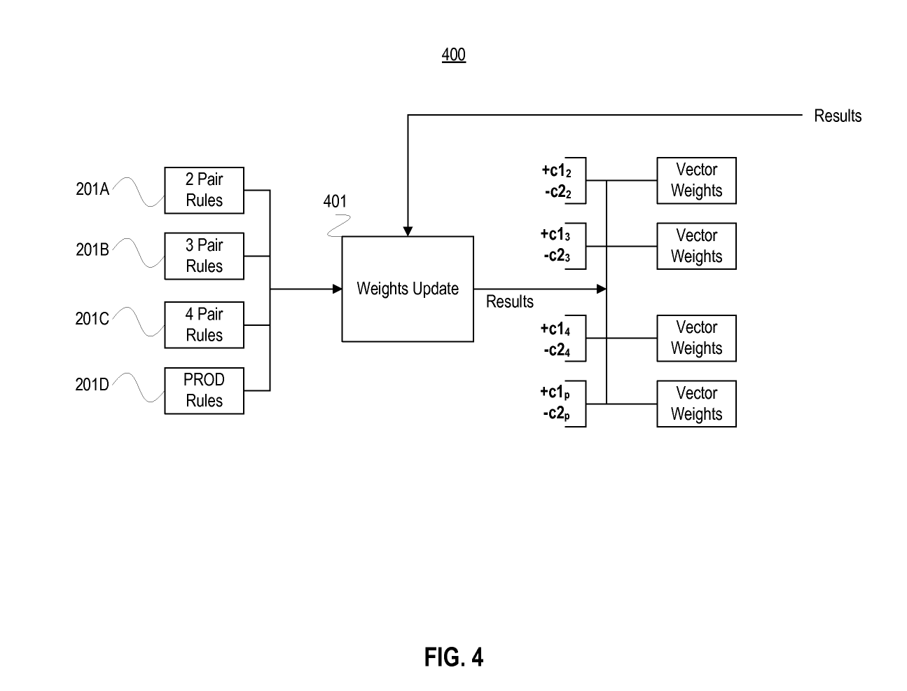

FIG. 4 illustrates an example weight updating process 400 for updating weights associated with each rule, consistent with the disclosed embodiments. Weights update module 401 receives data (“results”) associated with each defect that was matched against a rule. The results indicate whether the match between the defects was correct. A match between a first defect and one or more other defects is correct if the match led to a correct determination that solving the first defect partially or fully solved the other defect(s). For example, if a 2-pair rule matched a first defect to a second defect, resulting in a determination that the second defect is a “false positive,” the indication regarding that second defect would indicate whether the second defect was in fact a false positive. For each rule matching that is accurate (e.g., a defect marked as “false positive” that actually turned out to be false positive), a weight associated with the rule is increased by a set amount. For each inaccurate rule matching (e.g., a defect marked as “false positive” that was not actually solved by solving another defect), a weight associated with the rule is decreased by a set amount. In some embodiments, the weights may be increased or decreased based on a constant that depends on what type of rule it is (e.g., 2-pair, 3-pair, 4-pair, or Prod) as well as whether the rule matching was accurate (e.g., whether a rule marked “false positive” actually turned out to be false positive). As shown in FIG. 4, each set of vector weights 202A-202D is modified by a different value based on whether the rule matching was accurate or not. For example, if one of 2-pair rules 201A was used to match a first defect and a second defect, and solving the first defect fully solved the second defect, the weight associated with that rule may be increased by a constant, c1₂. As another example, if a 4-pair rule matched four defects, which led to three defects being matched as false positive, but none were actually solved by the fourth defect, the weight associated with the rule is reduced by a constant, c2₄.

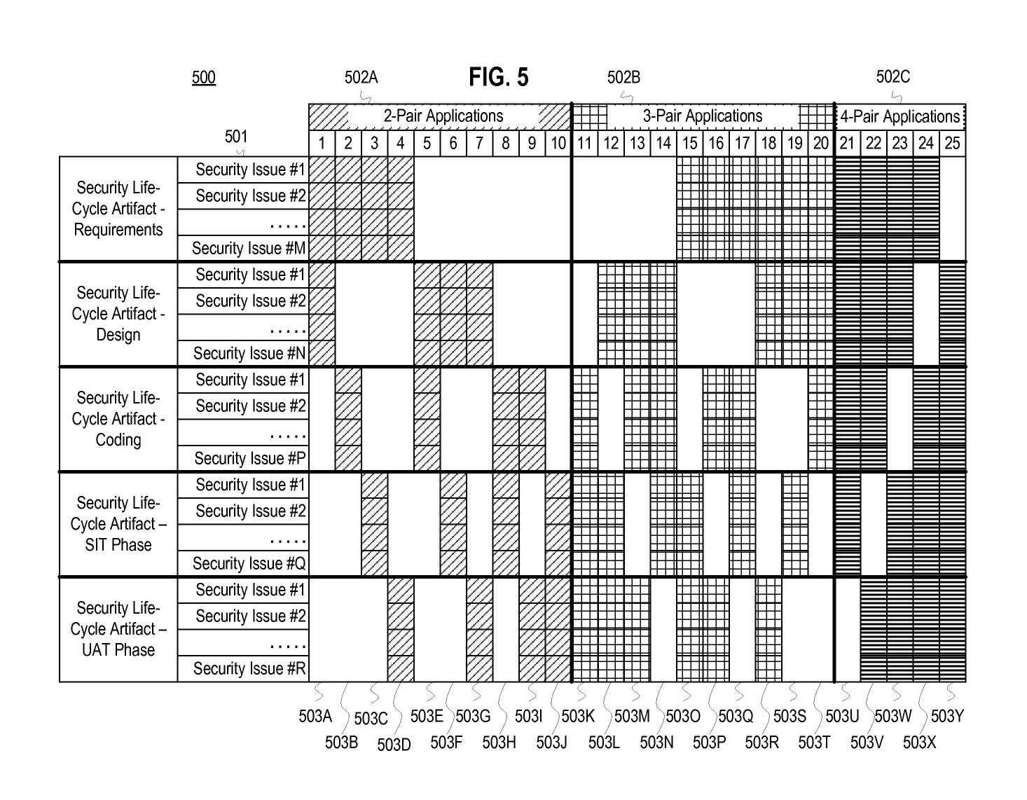

FIG. 5 illustrates an example rule application 500 of 2-pair, 3-pair, and 4-pair rules to security defects across phases of the SDLC, consistent with the disclosed embodiments. Rule application 500 enables the application of each security defect from defects 501 from each stage to be matched against other security defects from other stages. As explained above, a 2-pair rule matches a first defect from one stage and a second defect from a different stage, while a 3-pair rule matches a first defect from one stage, a second defect from a second stage, and a third defect from a third stage. The shaded boxes in each of 2-pair (rule) applications 502A, 3-pair (rule) applications 502B, and 4-pair (rule) applications 502C indicate which defects are being matched against one another. For example, in the 1^{st} application 503A, 2-pair rules are used to match each of the security defects in the “requirements” phase against each of the security defects in the “design” phase, to determine whether solving a defect from the “requirements” phase will partially or fully solve any defects from the “design” phase. If so, false positive reduction module 101B and incident prioritization module 101A are used to determine whether or not the match between defects indicates that one of the defects will be solved if the other is solved. The 2^{nd} application 503B uses 2-pair rules to match each of the security defects in the “requirements” phase against each of the defects in the “coding” phase. Other types of rules are used in a similar way. For example, in the 11^{th} application 503K, a 3-pair rule is used to match each of the security defects in the “coding” phase with each of the defects in the “SIT” phase and the “UAT” phase. If a defect from the “coding” phase matches a defect in the “SIT” phase and a defect from the “UAT” phase, then false positive reduction module 101B and incident prioritization module 101A are used to determine whether or not the match between the three defects indicates that two of the defects will be solved if the third defect is solved. If so, the two defects may be marked as false positive or lowered in severity, as appropriate. One of ordinary skill will understand that while FIG. 5 depicts matching each defect in a stage one-by-one against each other defect in one or more other stages, that other arrangements are possible (e.g., by matching only those defects that are similar to one another).

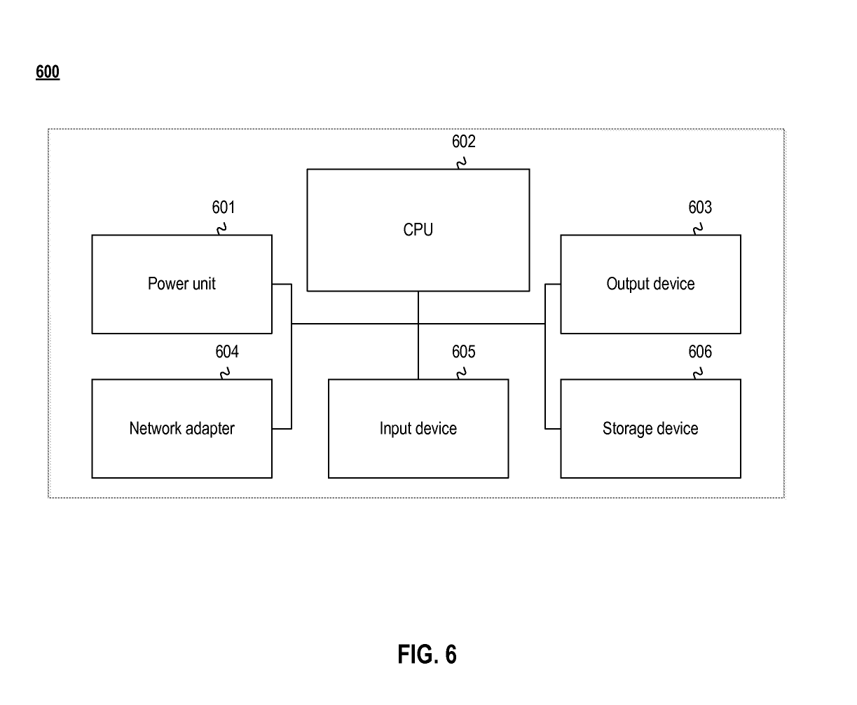

FIG. 6 illustrates an example computing device 600, consistent with the disclosed embodiments. Each component depicted in these figures (e.g., system 101, incident prioritization module 101A, false positive reduction module 101B) may be implemented as illustrated in device 600. In some embodiments, the components in FIG. 6 may be duplicated, substituted, or omitted. In some embodiments, device 600 can be implemented, as appropriate, as a mobile device, a personal computer, a server, a mainframe, a web server, a wireless device, or any other system that includes at least some of the components of FIG. 6. Each of the components in FIG. 6 can be connected to one another using, for example, a wired interconnection system such as a bus.

Device 600 comprises power unit 601. Power unit 601 can be implemented as a battery, a power supply, or the like. Power unit 601 provides the electricity necessary to power the other components in device 600. For example, CPU 602 needs power to operate. Power unit 601 can provide the necessary electric current to power this component.

Device 600 contains a Central Processing Unit (CPU) 602, which enables data to flow between the other components and manages the operation of the other components in computer device 600. CPU 602, in some embodiments, can be implemented as a general-purpose hardware processor (such as an Intel- or AMD-branded processor), a special-purpose hardware processor (for example, a graphics-card processor or a mobile processor), or any other kind of hardware processor that enables input and output of data.

Device 600 also comprises output device 603. Output device 603 can be implemented as a monitor, printer, speaker, plotter, or any other device that presents data processed, received, or sent by computer device 600.

Device 600 also comprises network adapter 604. Network adapter 604, in some embodiments, enables communication with other devices that are implemented in the same or similar way as computer device 600. Network adapter 604, in some embodiments, may allow communication to and/or from a network such as the Internet. Network adapter 604 may be implemented using any known or as-yet-unknown wired or wireless technologies (such as Ethernet, 802.11a/b/g/n (aka Wi-Fi), cellular (e.g. GSM, CDMA, LTE), or the like).

Device 600 also comprises input device 605. In some embodiments, input device 605 may be any device that enables a user to input data. For example, input device 605 could be a keyboard, a mouse, or the like. Input device 605 can be used to control the operation of the other components illustrated in FIG. 6.

Device 600 also includes storage device 606. Storage device 606 stores data that is usable by the other components in device 600. Storage device 606 may, in some embodiments, be implemented as a hard drive, temporary memory, permanent memory, optical memory, or any other type of permanent or temporary storage device. Storage device 606 may store one or more modules of computer program instructions and/or code that creates an execution environment for the computer program in question, such as, for example, processor firmware, a protocol stack, a database management system, an operating system, or a combination thereof.

The term “processor system,” as used herein, refers to one or more processors (such as CPU 602). The disclosed systems may be implemented in part or in full on various computers, electronic devices, computer-readable media (such as CDs, DVDs, flash drives, hard drives, or other storage), or other electronic devices or storage devices. The methods and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). While disclosed processes include particular process flows, alternative flows or orders are also possible in alternative embodiments.

Certain features which, for clarity, are described in this specification in the context of separate embodiments may also be provided in combination in a single embodiment. Conversely, various features which, for brevity, are described in the context of a single embodiment may also be provided in multiple embodiments separately or in any suitable sub-combination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments have been described. Other embodiments are within the scope of the following claims.

Other embodiments will be apparent to those skilled in the art from consideration of the specification and practice of the disclosed embodiments. It is intended that the specification and examples be considered as exemplary only, with a true scope and spirit of the embodiments being indicated by the following claims.

What is claimed is:

1. A method for presenting security defects comprising:
receiving a set of security defects, each security defect being associated with a severity level and with a development stage in a systems development process;
applying, using at least one hardware processor, at least one rule of at least one set of rules to at least one defect of the received set of security defects, to determine if a risk associated with the at least one defect is reduced, wherein each rule is associated with a weight representing a probability that the rule correctly predicts that the risk is reduced;
based on the step of applying, determining which of the rules applied to the at least one defect, and modifying the severity level associated with the at least one defect;
presenting the received set of security defects, based at least on the severity level associated with each defect and the weight associated with an applied rule.

2. The method of claim 1, wherein:
applying at least one rule comprises applying a rule to determine whether solving a first defect in a first development stage at least partially solves another of the defects, by determining whether the first security defect is related to at least one of i) a second security defect in a second development stage, ii) a third security defect in a third development stage, or iii) a fourth security defect in a fourth development stage; and
wherein the weight associated with the at least one rule represents a probability that the rule correctly predicts that solving a first defect will at least partially solve one or more of the second, third, or fourth defects.

3. The method of claim 2, wherein if it is determined that solving the first security defect partially solves the second security defect, reducing the severity level of the second security defect, where solving the first security defect partially solves the second security defect if solving the first security defect reduces a risk associated with the second security defect.

4. The method of claim 2, wherein if it is determined that solving a first security defect will fully solve the second security defect, marking the second security defect to be a false positive defect.

5. The method of claim 2, wherein solving a security defect comprises at least one of i) modifying software code associated with the security defect, ii) modifying a development artifact associated with the security defect, or iii) modifying a production environment related to the systems development process.

6. The method of claim 1, wherein
applying at least one rule comprises applying a production rule to determine whether at least one change in a production environment will partially or fully solve a defect; and
wherein the weight associated with the at least one rule represents a probability that the rule correctly predicts that making the at least one change in the production environment will at least partially solve the defect.

7. The method of claim 1, further comprising:
receiving results indicating which of the at least one rules was applied and whether the application of the at least one rules led to a correct security defect mitigation; and
based on the results, updating the weight associated with each applied rule.

8. A system for presenting security defects comprising:
at least one hardware processor; and
storage comprising instructions that, when executed by the at least one computer processor, cause the at least one computer processor to perform a method comprising:
receiving a set of security defects, each security defect being associated with a severity level and with a development stage in a systems development process;
applying at least one rule of at least one set of rules to at least one defect of the received set of security defects, to determine if a risk associated with the at least one defect is reduced, wherein each rule is associated with a weight representing a probability that the rule correctly predicts that the risk is reduced;
based on the step of applying, determining which of the rules applied to the at least one defect, and modifying the severity level associated with the at least one defect;
presenting the received set of security defects, based at least on the severity level associated with each defect and the weight associated with an applied rule.

9. The system of claim 8, wherein:
applying at least one rule comprises applying a rule to determine whether solving a first defect in a first development stage at least partially solves another of the defects, by determining whether the first security defect is related to at least one of i) a second security defect in a second development stage, ii) a third security defect in a third development stage, or iii) a fourth security defect in a fourth development stage; and
wherein the weight associated with the at least one rule represents a probability that the rule correctly predicts that solving a first defect will at least partially solve one or more of the second, third, or fourth defects

10. The system of claim 9, wherein if it is determined that solving the first security defect partially solves the second security defect, reducing the severity level of the second security defect, where solving the first security defect partially solves the second security defect if solving the first security defect reduces a risk associated with the second security defect.

11. The system of claim 9, wherein if it is determined that solving a first security defect will fully solve the second security defect, marking the second security defect to be a false positive defect.

12. The system of claim 9, wherein solving a security defect comprises at least one of i) modifying software code associated with the security defect, ii)modifying a development artifact associated with the security defect, or iii) modifying a production environment related to the systems development process.

13. The system of claim 8, wherein
applying at least one rule comprises applying a production rule to determine whether at least one change in a production environment will partially or fully solve a defect; and
wherein the weight associated with the at least one rule represents a probability that the rule correctly predicts that making the at least one change in the production environment will at least partially solve the defect.

14. The system of claim 8, wherein the instructions are further configured to cause the at least one processor to:
receive results indicating which of the at least one rules was applied and whether the application of the at least one rules led to a correct security defect mitigation; and
based on the results, update a weight associated with each applied rule.

15. A non-transitory computer-readable medium storing instructions that, when executed by at least one computer processor, cause the at least one computer processor to perform a method comprising:
receiving a set of security defects, each security defect being associated with a severity level and with a development stage in a systems development process;
applying at least one rule of at least one set of rules to at least one defect of the received set of security defects, to determine if a risk associated with the at least one defect is reduced, wherein each rule is associated with a weight representing a probability that the rule correctly predicts that the risk is reduced;
based on the step of applying, determining which of the rules applied to the at least one defect, and modifying the severity level associated with the at least one defect;
presenting the received set of security defects, based at least on the severity level associated with each defect and the weight associated with an applied rule.

16. The medium of claim 15, wherein:
applying at least one rule comprises applying a rule to determine whether solving a first defect in a first development stage at least partially solves another of the defects, by determining whether the first security defect is related to at least one of i) a second security defect in a second development stage, ii) a third security defect in a third development stage, or iii) a fourth security defect in a fourth development stage; and
wherein the weight associated with the at least one rule represents a probability that the rule correctly predicts that solving a first defect will at least partially solve one or more of the second, third, or fourth defects

17. The medium of claim 16, wherein if it is determined that solving the first security defect partially solves the second security defect, reducing the severity level of the second security defect, where solving the first security defect partially solves the second security defect if solving the first security defect reduces a risk associated with the second security defect.

18. The medium of claim 16, wherein if it is determined that solving a first security defect will fully solve the second security defect, marking the second security defect to be a false positive defect.

19. The medium of claim 15, wherein
applying at least one rule comprises applying a production rule to determine whether at least one change in a production environment will partially or fully solve a defect; and
wherein the weight associated with the at least one rule represents a probability that the rule correctly predicts that making the at least one change in the production environment will at least partially solve the defect.

20. The system of claim 8, wherein the instructions are further configured to cause the at least one processor to:
receive results indicating which of the at least one rules was applied and whether the application of the at least one rules led to a correct security defect mitigation; and
based on the results, update a weight associated with each applied rule.
